(19) United States
(12) Patent Application Publication
(10) Pub. No.: US 2026/0341010 A1
(43) Pub. Date: Oct. 29, 2026

(54) SCENE GRAPH INFORMATION GENERATION APPARATUS, SCENE GRAPH INFORMATION GENERATION METHOD, TRAINING APPARATUS, AND TRAINING METHOD

(71) Applicants: TOYOTA JIDOSHA KABUSHIKI KAISHA, Aichi-ken (JP); University of Washington, Seattle, WA (US)

(72) Inventors: Quan KONG, Tokyo-to (JP); Norimasa KOBORI, Tokyo-to (JP); Ashutosh KUMAR, Tokyo-to (JP); Jingjing PAN, Tokyo-to (JP); Mustafa ERDOGAN, Tokyo-to (JP); Rajat SAINI, Tokyo-to (JP); Ranjay KRISHNA, Seattle, WA (US); Jae Sung PARK, Seattle, WA (US); Zixian MA, Seattle, WA (US); Linjie LI, Seattle, WA (US); Chenhao ZHENG, Seattle, WA (US); Cheng-Yu HSIEH, Seattle, WA (US); Ximing LU, Seattle, WA (US); Khyathi CHANDU, Seattle, WA (US); Ali FARHADI, Seattle, WA (US); Yejin CHOI, Seattle, WA (US)

(21) Appl. No.: 19/660,091

(22) Filed: Apr. 27, 2026

(30) Foreign Application Priority Data
Apr. 28, 2025 (JP) 2025-074996

(51) Int. Cl. G06V 10/86; G06V 10/26; G06V 10/74; G06V 10/774; G06V 20/70

(52) U.S. Cl. CPC G06V 10/86; G06V 10/267; G06V 10/761; G06V 10/774; G06V 20/70

(57) ABSTRACT

A scene graph information generation apparatus includes an annotated image acquisition interface that acquires a first annotated image obtained by assigning multiple annotations to an image, a scene list acquisition interface that, by inputting the first annotated image into a first model, acquires a scene list that describes, for each object in the image, a description of the object and relations with other objects, and a list filter that removes a description of an incorrect relation from the scene list.

### CROSS-REFERENCE TO RELATED APPLICATION

This application claims priority to Japanese Patent Application No. 2025-074996, filed on Apr. 28, 2025, the entire contents of which are incorporated herein by reference.

### TECHNICAL FIELD

The present disclosure relates to a scene graph information generation apparatus, a scene graph information generation method, a training apparatus, and a training method.

### BACKGROUND

Technology for generating scene graphs that describe the relations between objects in images using graph models is known. For example, Patent Literature (PTL) 1 discloses technology in which objects are detected from an image using an object detection method based on deep learning, a context situation in the image is detected using a PLSI, the relations between the objects are detected using deep learning-based relation detection and an ontology method, and a scene graph for the input image is generated.

### CITATION LIST

### Patent Literature

PTL 1: JP 2021-197129 A

### SUMMARY

However, annotating scene graphs is difficult, which makes it difficult to improve accuracy and requires a significant amount of time and cost. Therefore, technology for efficiently generating accurate scene graphs is required. Moreover, tuning of Multimodal Large Language Models (MLLMs) is mainly conducted using unstructured data, and tuning of MLLMs using structured data has not been researched yet.

It would be helpful to provide a scene graph information generation apparatus, a scene graph information generation method, a training apparatus, and a training method capable of efficiently generating an accurate scene graph.

A scene graph information generation apparatus according to an embodiment of the present disclosure includes:
an annotated image acquisition interface configured to acquire a first annotated image obtained by assigning multiple annotations to an image;
a scene list acquisition interface configured to, by inputting the first annotated image into a first model, acquire a scene list that describes, for each object in the image, a description of the object and relations with other objects; and
a list filter configured to remove a description of an incorrect relation from the scene list.

A scene graph information generation method according to an embodiment of the present disclosure includes:
acquiring, by a scene graph information generation apparatus, a first annotated image obtained by assigning multiple annotations to an image;
by inputting the first annotated image into a first model, acquiring, by the scene graph information generation apparatus, a scene list that describes, for each object in the image, a description of the object and relations with other objects; and
removing, by the scene graph information generation apparatus, a description of an incorrect relation from the scene list.

A training apparatus according to an embodiment of the present disclosure includes:
a trainer configured to train, using a correct label assigned to an image, a model for generating scene graph information for the image; and
a second scene graph information acquisition interface configured to acquire second scene graph information obtained by modifying the scene graph information generated by the model,
wherein the correct label includes the second scene graph information.

A training method according to an embodiment of the present disclosure includes:
training, by a training apparatus, a model for generating scene graph information for an image;
generating, by the training apparatus, scene graph information by inputting an image into the model;
acquiring, by the training apparatus, second scene graph information obtained by modifying the scene graph information generated by the model; and
re-training, by the training apparatus, the model using the second scene graph information.

According to the present disclosure, it becomes possible to efficiently generate accurate scene graphs.

### BRIEF DESCRIPTION OF THE DRAWINGS

In the accompanying drawings:

FIG. 1 is a block diagram illustrating an example of a configuration of a scene graph information generation apparatus according to an embodiment;

FIG. 2 is a diagram illustrating an example of a scene list generated from an annotated image;

FIG. 3 is a diagram illustrating an example of filtering the scene list illustrated in FIG. 2;

FIG. 4 is a flowchart illustrating an example of a procedure of a scene graph information generation method by a scene graph information generation apparatus according to an embodiment;

FIG. 5 is a block diagram illustrating an example of a configuration of a training apparatus according to an embodiment;

FIG. 6 is a diagram that describes processing of a second scene graph information acquisition interface in a training apparatus according to an embodiment; and

FIG. 7 is a flowchart illustrating an example of a procedure of a training method by a training apparatus according to an embodiment.

### DETAILED DESCRIPTION

Embodiments of the present disclosure will be described in detail below, with reference to the drawings.

### Scene Graph Information Generation Apparatus

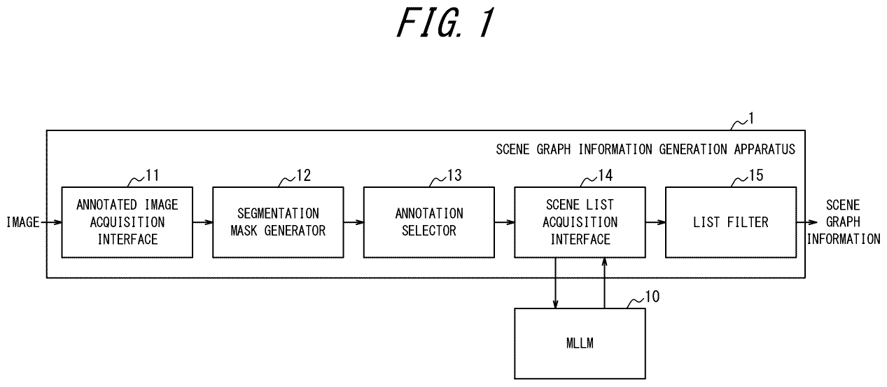

FIG. 1 is a block diagram illustrating an example of a configuration of a scene graph information generation apparatus according to an embodiment. A scene graph information generation apparatus 1 illustrated in FIG. 1 includes an annotated image acquisition interface 11, a segmentation mask generator 12, an annotation selector 13, a scene list acquisition interface 14, and a list filter 15.

The annotated image acquisition interface 11 acquires (collects), as a seed dataset, a first annotated image obtained by assigning multiple accurate annotations to an image. The annotated image may include depth information on the image. The annotated image acquisition interface 11 may collect the annotated image from a dataset such as COCO, LVIS, RefCOCO, or Visual Genome. The annotated image acquisition interface 11 outputs the acquired annotated image to the segmentation mask generator 12 and the annotation selector 13.

The segmentation mask generator 12 generates a segmentation mask for the first annotated image. The segmentation mask is an image divided into multiple mask regions, and can be generated, for example, using SAM, Semantic-SAM, or the like. The segmentation mask generator 12 outputs the generated segmentation mask to the annotation selector 13.

The annotation selector 13 calculates, for each region (annotation region) to which an annotation is assigned in the annotated image input from the annotated image acquisition interface 11, the similarity between the annotation region and each mask region of the segmentation mask input from the segmentation mask generator 12. When the similarity between the annotation region and a mask region exceeds a threshold, the annotation selector 13 retains the annotation corresponding to that annotation region. When the similarity between the annotation region and any mask region is equal to or less than the threshold, the annotation selector 13 removes the annotation corresponding to that annotation region. The similarity may be an Intersection over Union (IoU) value. The larger the similarity (the closer the IoU value is to 1), the more important the annotation is considered to be, contributing significantly to the understanding of the scene. Therefore, the annotation selector 13 enables the generation of a scene graph by focusing on visually clear and meaningful elements. The annotation selector 13 outputs the processed annotated image (second annotated image) to the scene list acquisition interface 14.

The scene list acquisition interface 14 inputs the second annotated image, which is input from the annotation selector 13, into an existing pre-trained multimodal large language model (MLLM) 10 such as GPT4-V. The scene list acquisition interface 14 instructs the MLLM 10 to select a predetermined number of objects from the second annotated image and generate a scene list in which, for each of the selected objects, a description of the object and relations with other objects are described. This instruction may be performed by a user entering a prompt into the MLLM 10. The scene list acquisition interface 14 acquires the scene list generated by the MLLM 10, and outputs the scene list to the list filter 15.

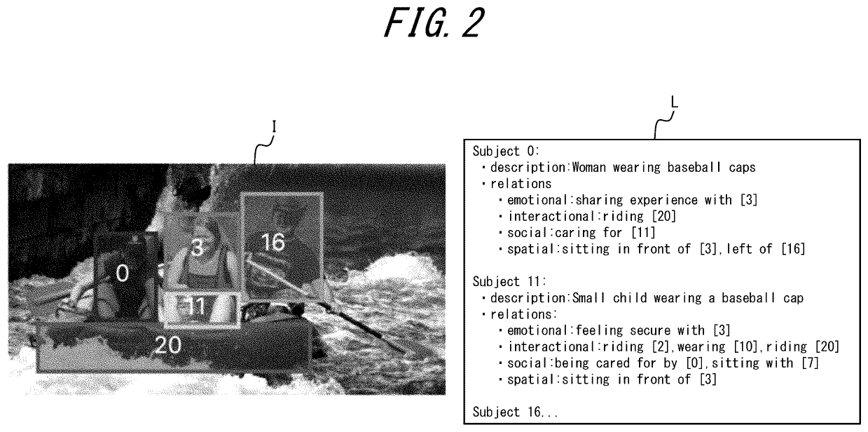

FIG. 2 is a diagram illustrating an example of the scene list generated from the annotated image. FIG. 2 illustrates an example in which the scene list acquisition interface 14 instructs the MLLM 10 to select five objects from a second annotated image I and generate a scene list in which, for each object, a description of the object and spatial, interactional, functional, social, and emotional relations with other objects are described. In FIG. 2, for ease of visual understanding of the position of each object, regions of the five objects selected by the MLLM 10 are enclosed by rectangles and accompanied by subject numbers, within the second annotated image I. In FIG. 2, a scene list L generated by the MLLM 10 is illustrated on the right. The numbers in brackets indicate the subject numbers.

The list filter 15 filters (modifies) the scene list input from the scene list acquisition interface 14 according to predetermined rules to remove descriptions of incorrect relations, and generates a filtered scene list as scene graph information. The list filter 15 may filter the scene list using a different model (for example, visual language model such as CLIP or LLaVA) from the MLLM 10. In this specification, scene graph information refers to information necessary to generate a scene graph. A scene graph is what the relations between objects are visualized using nodes and edges based on scene graph information.

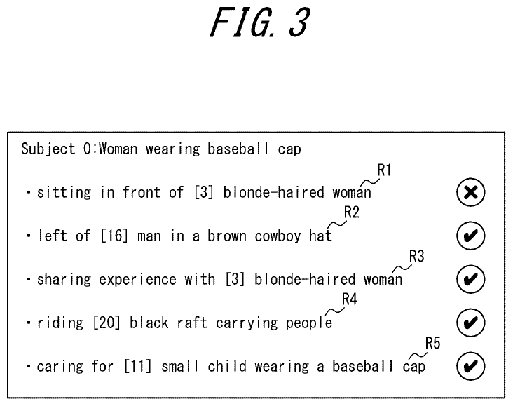

FIG. 3 is a diagram illustrating an example of filtering the scene list L illustrated in FIG. 2. For example, in FIG. 2, for the object with subject number 0, the spatial relation with other objects is described as “sitting in front of [3], left of [16].” This description can be divided into two parts: “sitting in front of [3]” and “left of [16].” In FIG. 3, the description of the relation is divided as described above for each object, and the descriptions of the corresponding objects are described to the right of the subject numbers. For example, “blonde-haired woman” is described to the right of “[3].” For the object with subject number 0 (woman wearing a baseball cap), the description R1 of the relation of sitting in front of the object with subject number 3 (blonde-haired woman) is incorrect, so the description R1 is removed from the scene list L. For the object with subject number 0 (woman wearing a baseball cap), the descriptions R2 to R5 of the relations are correct, and therefore retained in the scene list L.

The scene graph information generation apparatus 1 may not include the segmentation mask generator 12 and the annotation selector 13. In this case, the scene list acquisition interface 14 inputs the first annotated image, which is acquired by the annotated image acquisition interface 11, into the MLLM 10 and acquires a scene list generated by the MLLM 10.

### Scene Graph Information Generation Method

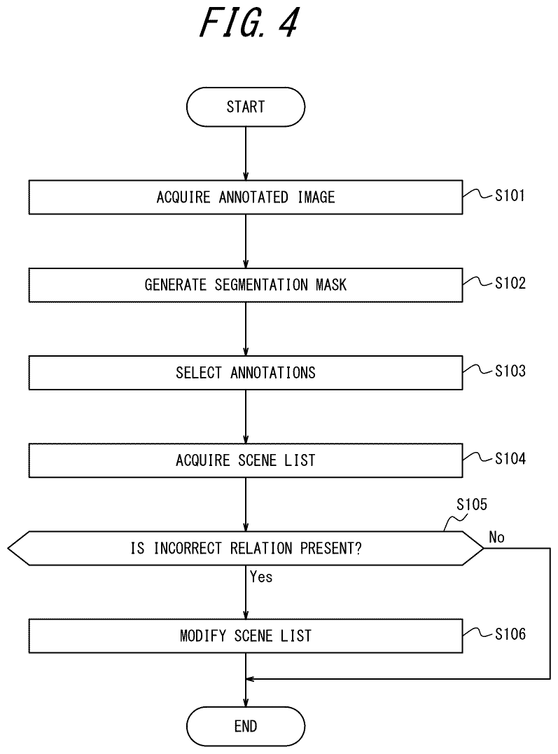

Next, a scene graph information generation method performed by the scene graph information generation apparatus 1 will be described. FIG. 4 is a flowchart illustrating an example of a procedure of the scene graph information generation method.

In step S101, the annotated image acquisition interface 11 acquires an annotated image.

In step S102, the segmentation mask generator 12 generates a segmentation mask for the annotated image.

In step S103, the annotation selector 13 calculates IoU between each annotation region in the annotated image and each mask region of the segmentation mask. When the IoU is equal to or less than a threshold (for example, 0.5), the annotation selector 13 removes the annotation corresponding to the annotation region.

In step S104, the scene list acquisition interface 14 inputs the annotated image to the MLLM 10 to acquire a scene list in which, for each object in the annotated image, a description of the object and relations with other objects are described.

In step S105, the list filter 15 determines whether an incorrect relation is present.

In step S106, when an incorrect relation is present, the list filter 15 modifies the scene list and removes the description of the incorrect relation from the scene list. An accurate scene graph is generated from the modified scene graph information.

As described above, according to the present disclosure, by acquiring an annotated image, a scene graph can be generated efficiently. By removing a description of an inappropriate relation from a scene list, a highly accurate scene graph can be generated. By removing a less important annotation, among annotations assigned to the image, a more highly accurate scene graph can be generated.

### Training Apparatus

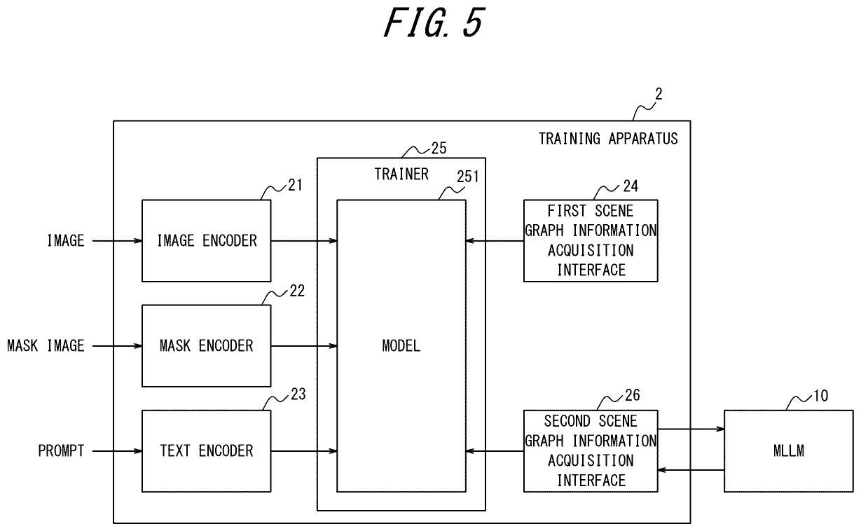

FIG. 5 is a block diagram illustrating an example of a configuration of a training apparatus according to an embodiment. A training apparatus 2 illustrated in FIG. 5 includes an image encoder 21, a mask encoder 22, a text encoder 23, a first scene graph information acquisition interface 24, a trainer 25, and a second scene graph information acquisition interface 26.

The image encoder 21 encodes an image (extracts features from an image) to generate an image vector. The image encoder 21 outputs the generated image vector to the trainer 25.

The mask encoder 22 encodes a mask image obtained by masking the image on a region-by-region basis, to generate a mask image vector. The mask encoder 22 outputs the generated mask image vector to the trainer 25.

The text encoder 23 encodes a prompt to generate a text vector. The prompt is a text that instructs the generation of scene graph information, such as “Please describe the relations between objects in the image.” The text encoder 23 outputs the generated text vector to the trainer 25.

The first scene graph information acquisition interface 24 acquires ground-truth first scene graph information. The first scene graph information may be scene graph information generated by the scene graph information generation apparatus 1 described above. The first scene graph information acquisition interface 24 outputs the acquired first scene graph information to the trainer 25.

The trainer 25 trains a model 251, which generates scene graph information for an image, using the image vector input from the image encoder 21, the mask image vector input from the mask encoder 22, the text vector input from the text encoder 23, and correct labels assigned to the image. In a first stage of training (instruction tuning), the trainer 25 uses the ground-truth first scene graph information as correct labels. The trainer 25 outputs scene graph information generated by the model 251 to the second scene graph information acquisition interface 26.

The second scene graph information acquisition interface 26 modifies, using an existing pre-trained multimodal large language model (MLLM) 10 such as GPT4-V, the scene graph information generated by the model 251. The second scene graph information acquisition interface 26 outputs, to the trainer 25, the modified scene graph information as second scene graph information. Note that, the same reference numeral “10” is assigned to the MLLM illustrated in FIG. 1 and the MLLM illustrated in FIG. 5, but these MLLMs do not have to be the same model.

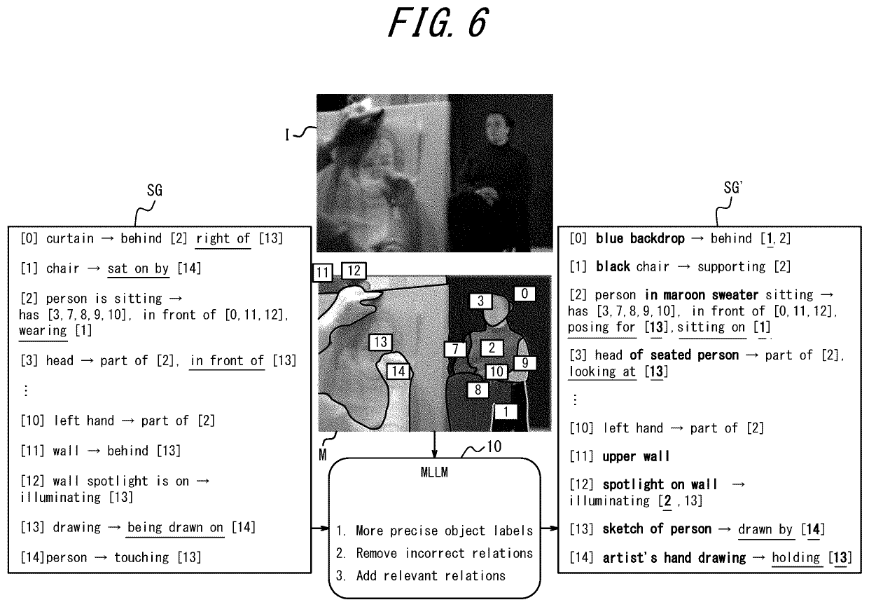

FIG. 6 is a diagram that describes processing of the second scene graph information acquisition interface 26. Assuming that the model 251 has generated scene graph information SG using an image I and a mask image M, which is obtained by masking the image I on a region-by-region basis. The second scene graph information acquisition interface 26 inputs, into the MLLM 10, the scene graph information SG and the mask image M corresponding to the scene graph information SG. The second scene graph information acquisition interface 26 instructs the MLLM 10 to describe more precise object labels, remove incorrect relations, and add relevant relations. Then, the MLLM 10 modifies (edits) the scene graph information and generates second scene graph information SG′. In FIG. 6, the differences between the scene graph information SG and the second scene graph information SG′ are indicated by underlining and bold text. For example, for a person labeled [2], the MLLM 10 removes an incorrect relation “wearing [1] (chair),” changes the description to [2] person being “in maroon sweater,” and adds relations of “posing for [13]” and “sitting on [1].”

In a second stage of training (instruction tuning), the trainer 25 uses the second scene graph information SG′ as correct labels. That is, the trainer 25 re-trains the model 251 using the image I, the mask image M obtained by masking the image I on a region-by-region basis, and the second scene graph information SG′.

### Training Method

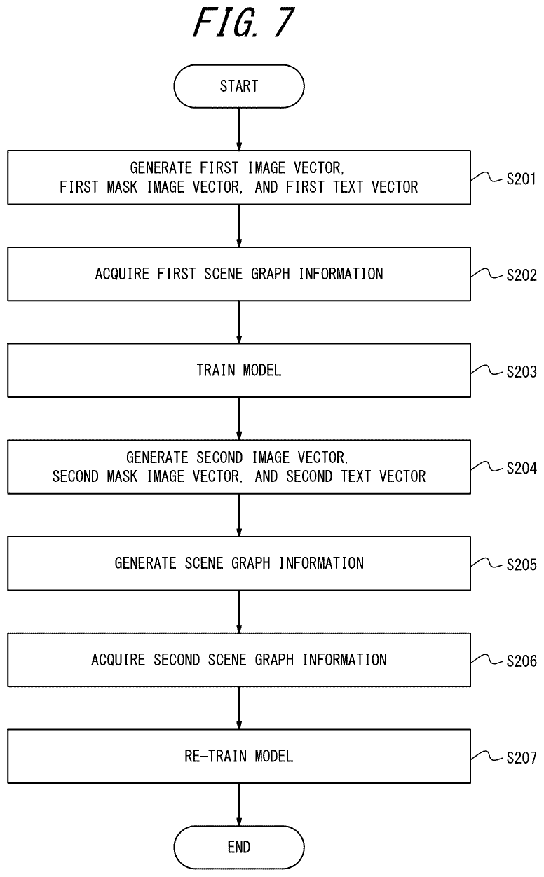

Next, a training method by the training apparatus 2 will be described. FIG. 7 is a flowchart illustrating an example of a procedure of the training method.

In step S201, the image encoder 21 generates a first image vector by encoding a first image. The mask encoder 22 generates a first mask image vector by encoding a mask image obtained by masking the first image on a region-by-region basis. The text encoder 23 generates a first text vector by encoding a prompt that instructs the generation of scene graph information for the first image.

In step S202, the first scene graph information acquisition interface 24 acquires, as correct labels for the first image, first scene graph information that describes the relations between objects in the first image.

In step S203, the trainer 25 trains the model 251, which generates scene graph information, using the first image vector, the first mask image vector, the first text vector, and the first scene graph information. The trainer 25 may also train the mask encoder 22 simultaneously. Processing from step S201 to step S203 are repeatedly performed using multiple first images.

In step S204, the image encoder 21 generates a second image vector by encoding a second image. The mask encoder 22 generates a second mask image vector by encoding a mask image obtained by masking the second image on a region-by-region basis. The text encoder 23 generates a second text vector by encoding a prompt that instructs the generation of scene graph information for the second image.

In step S205, the model 251 generates scene graph information upon input of the second image vector, the second mask image vector, and the second text vector.

In step S206, the second scene graph information acquisition interface 26 inputs the second mask image, the scene graph information generated by the model 251, and predetermined rules into the MLLM 10, which is a different pre-trained model from the model 251, to acquire second scene graph information.

In step S207, the trainer 25 re-trains the model 251 using the second image vector, the second mask image vector, the second text vector, and the second scene graph information. Processing from step S204 to step S207 are repeatedly performed using multiple second images.

As described above, the training apparatus 2 modifies the scene graph information generated by the model 251, and re-trains the model 251. Therefore, according to the present disclosure, it becomes possible to tune MLLMs using structured data.

### Program

It is also possible to cause a computer capable of executing program instructions to function as the scene graph information generation apparatus 1 or the training apparatus 2 as described above. A program can cause a computer to execute the operations described above, thereby enabling the computer to function as the scene graph information generation apparatus 1 or the training apparatus 2.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as a secure digital (SD) card, a digital versatile disc (DVD), or a compact disc read only memory (CD-ROM) on which the program is stored. The program may be distributed by storing the program in a storage of a server and transferring the program from the server to another computer. The program may be provided as a program product.

For example, the computer temporarily stores, in the memory, the program stored in the portable medium or the program transferred from the server. Then, the computer reads the program stored in the memory using a processor and executes processing in accordance with the read program using the processor. The computer may read the program directly from the portable medium, and execute processing in accordance with the program. The computer may, each time a program is transferred from the server to the computer, sequentially execute processing in accordance with the received program. Without transferring the program from the server to the computer, processing may be executed by a so-called application service provider (ASP) type service that realizes functions only by execution instructions and result acquisitions. The program encompasses information that is to be used for processing by an electronic computer and is thus equivalent to a program. For example, data that is not a direct command to a computer but has a property that regulates processing of the computer is “equivalent to a program” in this context.

The aforementioned embodiments have been explained as representative examples, but various modifications or changes can be made without departing from the spirit of the present disclosure. For example, it is possible to combine multiple configuration blocks or processing steps described in the embodiments into one, or to divide one into multiple blocks or steps.

Examples of some embodiments of the present disclosure are described below. However, it should be noted that the embodiments of the present disclosure are not limited to these examples.

[Appendix 1] A scene graph information generation apparatus comprising:
an annotated image acquisition interface configured to acquire a first annotated image obtained by assigning multiple annotations to an image;
a scene list acquisition interface configured to, by inputting the first annotated image into a first model, acquire a scene list that describes, for each object in the image, a description of the object and relations with other objects; and
a list filter configured to remove a description of an incorrect relation from the scene list.

[Appendix 2] The scene graph information generation apparatus according to appendix 1, comprising:
a segmentation mask generator configured to generate a segmentation mask for the image; and
an annotation selector configured to, when a similarity between a region of the image to which an annotation is assigned and any mask region of the segmentation mask is equal to or less than a threshold, output a second annotated image with annotations excluding that annotation,
wherein the scene list acquisition interface is configured to input the second annotated image, instead of the first annotated image, into the first model.

[Appendix 3] The scene graph information generation apparatus according to appendix 2, wherein the similarity is an IoU value.

[Appendix 4] A scene graph information generation method comprising:
acquiring, by a scene graph information generation apparatus, a first annotated image obtained by assigning multiple annotations to an image;
by inputting the first annotated image into a first model, acquiring, by the scene graph information generation apparatus, a scene list that describes, for each object in the image, a description of the object and relations with other objects; and
removing, by the scene graph information generation apparatus, a description of an incorrect relation from the scene list.

[Appendix 5] The scene graph information generation method according to appendix 4, comprising:
generating, by the scene graph information generation apparatus, a segmentation mask for the image; and
when a similarity between a region of the image to which an annotation is assigned and any mask region of the segmentation mask is equal to or less than a threshold, outputting, by the scene graph information generation apparatus, a second annotated image with annotations excluding that annotation,
wherein instead of the first annotated image, the second annotated image is input into the first model.

[Appendix 6] The scene graph information generation method according to appendix 5, wherein the similarity is an IoU value.

[Appendix 7] A training apparatus comprising:
a trainer configured to train, using a correct label assigned to an image, a model for generating scene graph information for the image; and
a second scene graph information acquisition interface configured to acquire second scene graph information obtained by modifying the scene graph information generated by the model,
wherein the correct label includes the second scene graph information.

[Appendix 8] The training apparatus according to appendix 7, comprising:
an image encoder configured to generate an image vector by encoding the image;
a mask encoder configured to generate a mask image vector by encoding a mask image obtained by masking the image on a region-by-region basis; and
a text encoder configured to generate a text vector by encoding a prompt that instructs generation of scene graph information for the image,
wherein the trainer is configured to train the model using the image vector, the mask image vector, the text vector, and the correct label.

[Appendix 9] The training apparatus according to appendix 7 or 8, wherein the second scene graph information acquisition interface is configured to acquire the second scene graph information by inputting a mask image obtained by masking the image on a region-by-region basis, the scene graph information output by the model, and a predetermined rule into a different pre-trained model from the model.

[Appendix 10] The training apparatus according to any one of appendices 7 to 9, wherein
the correct label includes first scene graph information, and
the first scene graph information is obtained by a scene graph information generation apparatus configured to:
   acquire a first annotated image obtained by assigning multiple annotations to an image;
   by inputting the first annotated image into a first model, acquire a scene list that describes, for each object in the image, a description of the object and relations with other objects; and
   remove a description of an incorrect relation from the scene list.

[Appendix 11] A training method comprising:
training, by a training apparatus, a model for generating scene graph information for an image;
generating, by the training apparatus, scene graph information by inputting an image into the model;
acquiring, by the training apparatus, second scene graph information obtained by modifying the scene graph information generated by the model; and
re-training, by the training apparatus, the model using the second scene graph information.

[Appendix 12] The training method according to appendix 11, wherein the training of the model includes:
generating a first image vector by encoding a first image;
generating a first mask image vector by encoding a first mask image obtained by masking the first image on a region-by-region basis;
generating a first text vector by encoding a prompt that instructs generation of scene graph information for the first image;
acquiring first scene graph information that is a correct label for the first image; and
training the model for generating scene graph information, using the first image vector, the first mask image vector, the first text vector, and the first scene graph information.

[Appendix 13] The training method according to appendix 11 or 12, wherein the generating of the scene graph information includes:
generating a second image vector by encoding a second image;
generating a second mask image vector by encoding a second mask image obtained by masking the second image on a region-by-region basis;
generating a second text vector by encoding a prompt that instructs generation of scene graph information for the second image; and
generating the scene graph information by inputting the second image vector, the second mask image vector, and the second text vector into the model.

[Appendix 14] The training method according to appendix 13, wherein the acquiring of the second scene graph information includes acquiring the second scene graph information by inputting the second mask image, the scene graph information generated by the model, and a predetermined rule into a different pre-trained model from the model.

[Appendix 15] The training method according to any one of appendices 12 to 14, wherein the acquiring of the first scene graph information includes:
acquiring a first annotated image obtained by assigning multiple annotations to the first image;
by inputting the first annotated image into a first model, acquiring a scene list that describes, for each object in the first image, a description of the object and relations with other objects; and
removing a description of an incorrect relation from the scene list.

1. A scene graph information generation apparatus comprising:
an annotated image acquisition interface configured to acquire a first annotated image obtained by assigning multiple annotations to an image;
a scene list acquisition interface configured to, by inputting the first annotated image into a first model, acquire a scene list that describes, for each object in the image, a description of the object and relations with other objects; and
a list filter configured to remove a description of an incorrect relation from the scene list.

2. The scene graph information generation apparatus according to claim 1, comprising:
a segmentation mask generator configured to generate a segmentation mask for the image; and
an annotation selector configured to, when a similarity between a region of the image to which an annotation is assigned and any mask region of the segmentation mask is equal to or less than a threshold, output a second annotated image with annotations excluding that annotation,
wherein the scene list acquisition interface is configured to input the second annotated image, instead of the first annotated image, into the first model.

3. The scene graph information generation apparatus according to claim 2, wherein the similarity is an IoU value.

4. A scene graph information generation method comprising:
acquiring, by the scene graph information generation apparatus according to claim 1, a first annotated image obtained by assigning multiple annotations to an image;
by inputting the first annotated image into a first model, acquiring, by the scene graph information generation apparatus, a scene list that describes, for each object in the image, a description of the object and relations with other objects; and
removing, by the scene graph information generation apparatus, a description of an incorrect relation from the scene list.

5. The scene graph information generation method according to claim 4, comprising:
generating, by the scene graph information generation apparatus, a segmentation mask for the image; and
when a similarity between a region of the image to which an annotation is assigned and any mask region of the segmentation mask is equal to or less than a threshold, outputting, by the scene graph information generation apparatus, a second annotated image with annotations excluding that annotation,
wherein instead of the first annotated image, the second annotated image is input into the first model.

6. The scene graph information generation method according to claim 5, wherein the similarity is an IoU value.

7. A training apparatus comprising:
a trainer configured to train, using a correct label assigned to an image, a model for generating scene graph information for the image; and
a second scene graph information acquisition interface configured to acquire second scene graph information obtained by modifying the scene graph information generated by the model,
wherein the correct label includes the second scene graph information.

8. The training apparatus according to claim 7, comprising:
an image encoder configured to generate an image vector by encoding the image;
a mask encoder configured to generate a mask image vector by encoding a mask image obtained by masking the image on a region-by-region basis; and
a text encoder configured to generate a text vector by encoding a prompt that instructs generation of scene graph information for the image,
wherein the trainer is configured to train the model using the image vector, the mask image vector, the text vector, and the correct label.

9. The training apparatus according to claim 7, wherein the second scene graph information acquisition interface is configured to acquire the second scene graph information by inputting a mask image obtained by masking the image on a region-by-region basis, the scene graph information output by the model, and a predetermined rule into a different pre-trained model from the model.

10. The training apparatus according to claim 7, wherein
the correct label includes first scene graph information, and
the first scene graph information is obtained by a scene graph information generation apparatus configured to:
acquire a first annotated image obtained by assigning multiple annotations to an image;
by inputting the first annotated image into a first model, acquire a scene list that describes, for each object in the image, a description of the object and relations with other objects; and
remove a description of an incorrect relation from the scene list.

11. A training method comprising:
training, by a training apparatus, a model for generating scene graph information for an image;
generating, by the training apparatus, scene graph information by inputting an image into the model;
acquiring, by the training apparatus, second scene graph information obtained by modifying the scene graph information generated by the model; and
re-training, by the training apparatus, the model using the second scene graph information.

12. The training method according to claim 11, wherein the training of the model includes:
generating a first image vector by encoding a first image;
generating a first mask image vector by encoding a first mask image obtained by masking the first image on a region-by-region basis;
generating a first text vector by encoding a prompt that instructs generation of scene graph information for the first image;
acquiring first scene graph information that is a correct label for the first image; and
training the model for generating scene graph information, using the first image vector, the first mask image vector, the first text vector, and the first scene graph information.

13. The training method according to claim 11, wherein the generating of the scene graph information includes:
generating a second image vector by encoding a second image;
generating a second mask image vector by encoding a second mask image obtained by masking the second image on a region-by-region basis;
generating a second text vector by encoding a prompt that instructs generation of scene graph information for the second image; and
generating the scene graph information by inputting the second image vector, the second mask image vector, and the second text vector into the model.

14. The training method according to claim 13, wherein the acquiring of the second scene graph information includes acquiring the second scene graph information by inputting the second mask image, the scene graph information generated by the model, and a predetermined rule into a different pre-trained model from the model.

15. The training method according to claim 12, wherein the acquiring of the first scene graph information includes:
acquiring a first annotated image obtained by assigning multiple annotations to the first image;
by inputting the first annotated image into a first model, acquiring a scene list that describes, for each object in the first image, a description of the object and relations with other objects; and
removing a description of an incorrect relation from the scene list.
